(19) United States
(12) Patent Application Publication
(10) Pub. No.: US 2007/0154641 A1
(43) Pub. Date: Jul. 5, 2007

(54) Thin-film forming method and mask used therefor

(75) Inventor: Kazuo Kobayashi, Kakamigahara-shi (JP)

Correspondence Address: Eugene LeDonne;Reed Smith LLP, 599 Lexington Avenue, New York, NY, 10022-7650, US

(73) Assignee: Brother Kogyo Kabushiki Kaisha

(21) Appl. No.: 11/648,442

(22) Filed: Dec. 29, 2006

(30) Foreign Application Priority Data
Dec. 30, 2005 (JP) 2005-380684

(51) Int. Cl. B05D 7/00; B05D 5/00; B05C 11/11

(52) U.S. Cl. 427/282; 427/421.1; 118/504

(57) ABSTRACT

Ultra-fine particles are jetted from a nozzle to be deposited on a substrate via a mask which is plate-shaped and in which an opening pattern is formed, thereby forming on the substrate a thin film having a shape corresponding to the opening pattern. The mask has a first area, a second area which surrounds the first area and defines an opening between the first area and the second area, and a bridge portion connecting the first and second areas. The bridge portion is formed at a position away from the bottom surface of the mask. By using this mask, a thin film having a pattern including an independent non-film formation area can be formed.

### CROSS REFERENCE TO RELATED APPLICATION

The present invention claims priority from Japanese Patent Application No. 2005-380684, filed on Dec. 30, 2005, the disclosure of which is incorporated herein by reference in its entirety.

### BACKGROUND OF THE INVENTION

1. Field of the Invention

The present invention relates to a method for forming, on a substrate, a thin film having a shape corresponding to an opening of a mask, and to a mask used for the method.

2. Description of the Related Art

Conventionally, as a method for forming a thin film, there is known aerosol deposition (AD method) for depositing aerosolized ultra-fine particles, jetted from a particle jetting apparatus, on a substrate to thereby form a thin film. With the AD method, a thin film having a fine shape can be formed.

In the AD method, it is also known to arrange, between a particle jetting apparatus and a substrate, a metal mask which is formed of metal in a plate shape and which has an opening with a predetermined pattern, and to jet the ultra-fine particles from the particle jetting apparatus onto the substrate through the opening of the metal mask while the particle jetting apparatus is displaced relative to the mask in a state that a distance between the metal mask and a growing surface, of the substrate, on which the thin film is grown is maintained to be constant or in a state that a distance between the metal mask and the surface of the substrate is maintained to be constant (see, for example, paragraph [0008] and FIG. 3 in Japanese Patent Application Laid-open No. 10-202171).

Further, it is also known to use a resist having an annular opening and to spray (blow) ultra-fine particles to the inside of the opening of the mask while rotating the substrate so as to form a thin film of ultra-fine particles in an annular shape (see, for example, paragraph [0022] and FIG. 3(c) in Japanese Patent Application Laid-open No. 06-093418).

In the technique described in Japanese Patent Application Laid-open No. 10-202171, the metal mask merely defines an outer contour of the opening and does not have, inside the opening, a portion or part defining an inner contour of the opening. Therefore, it is not possible to form a thin film having a pattern including an independent non-formation area (non-film formation area). Therefore, for example, it is not possible to concentrically form an annular non-formation area outside a circular non-formation area with a film-forming area being intervened therebetween.

On the other hand, in the technique described in Japanese Patent Application Laid-open No. 06-093418, when a thin film having a similar shape as described above is formed using a mask having an annular opening, the mask is separated into two members, and thus positioning of these two members becomes very difficult and hence unsuitable for any practical application. Further, although it is practically possible to use a resist instead of a mask to form a shield having a concentric opening pattern and thereby form a thin film having a pattern including an independent non-formation area, there still is a demand for a way or method to form a thin film of the above-described pattern with a metal mask which requires no exposing, developing, and resist removing steps. This is because the use of a reusable metal mask is simpler, requires low costs, and is excellent in productivity.

### SUMMARY OF THE INVENTION

An object of the present invention is to provide a method for forming a thin film having a pattern including an independent non-formation area using a mask, and a mask used therefor.

According to a first aspect of the present invention, there is provided a method for forming a thin film on a substrate, the method including: a first step for arranging, on the substrate, a plate-shaped mask which has a first area, a second area which is arranged to surround the first area, an opening which is defined between the first area and the second area and which has a predetermined pattern, and a bridge portion extending in a predetermined direction to connect the first and second areas across the opening and arranged with a predetermined gap from one surface of the mask; a step for arranging a particle jetting apparatus, which jets ultra-fine particles, at a position above the substrate and the mask; and a second step for jetting the ultra-fine particles by the particle jetting apparatus from a side of an upper surface of the mask so as to form a thin film, which has a shape corresponding to the predetermined pattern, on the substrate. Here, the term “mask” means a reusable mask such as a metal mask, for example.

Accordingly, a member in which the first area, the second area arranged to surround the first area and defining, between the first and second areas, an opening with a predetermined pattern are connected by the bridge portion extending between the first and second areas, is used as the plate-shaped mask to be arranged on the substrate. Therefore, a thin film having a pattern including an independent non-formation area can be formed easily on the substrate by, for example, the AD method. Further, since the bridge portion is formed at a position away from the bottom surface of the mask, a space (gap) exists between the substrate and the bridge portion when the bottom surface of the mask is brought into contact with the substrate. In this case, the ultra-fine particles also enter beneath a lower side of the bridge portion (pass through the bridge portion to enter to the gap between the substrate and the bridge portion), thereby forming a film. In other words, since the ultra-fine particles jetted from the particle jetting apparatus do not advance completely linearly but are jetted to spread to a certain extent, the ultra-fine particles enter beneath the lower side of the bridge portion of the mask in which the space exists between the bridge portion and the substrate, thereby forming a thin film having a shape corresponding to the pattern of the opening. Therefore, in the AD method for example, a thin film having a pattern including an independent non-formation area can be easily formed on a substrate by using a reusable mask.

In the method for forming the thin film according to the present invention, the bridge portion may be tapered toward the one surface of the mask.

Accordingly, the ultra-fine particles pass through the lower side (bottom surface side) of the bridge portion of the mask, which is advantageous for formation of the thin film having the shape corresponding to the pattern of the opening.

In the method for forming the thin film according to the present invention, in the second step, the particle jetting apparatus may jet the ultra-fine particles in a direction which is inclined with respect to the one surface of the mask and which intersects with the predetermined direction.

Accordingly, the ultra-fine particles can easily enter beneath the lower side of the bridge portion, which is advantageous for formation of the thin film having the shape corresponding to the pattern of the opening.

In the method for forming the thin film according to the present invention, in the second step, the particle jetting apparatus may jet the ultra-fine particles while moving reciprocally relative to the mask in a direction which is parallel to the one surface of the mask and is orthogonal to the predetermined direction. Here, the reciprocal movement may either be straight movement or rotational movement.

Accordingly, the ultra-fine particles can enter beneath the lower side of the bridge portion actively, which is advantageous for formation of the thin film having the shape corresponding to the pattern of the opening.

In the method for forming the thin film according to the present invention, the particle jetting apparatus may have a nozzle which jets the ultra-fine particles in a direction oblique to the mask.

Accordingly, the ultra-fine particles can enter beneath the lower side of the bridge portion more easily than in a case in which the ultra-fine particles are jetted in a vertical direction (perpendicular direction) to the mask, which is advantageous for formation of the thin film having the shape corresponding to the pattern of the opening.

In the method for forming the thin film according to the present invention, the particle jetting apparatus may have a first nozzle which jets the ultra-fine particles in a first direction inclined with respect to the one surface of the mask, and a second nozzle which jets the ultra-fine particles in a second direction inclined with respect to the one surface of the mask and different from the first direction; and in the second step, the ultra-fine particles may be jetted alternatively from one of the first nozzle and the second nozzle depending on a moving direction in which the particle jetting apparatus is moved relative to the mask.

Accordingly, it is possible to avoid the ultra-fine particles jetted from the first and second nozzles from colliding each other, thereby forming the thin film efficiently on the substrate.

In the method for forming the thin film according to the present invention, a cross-sectional shape of the bridge portion with respect to a plane orthogonal to the predetermined direction may be symmetrical.

Accordingly, the ultra-fine particles can easily go around the bridge portion to enter beneath the lower side of the bridge portion from the both sides of the bridge portion.

In the method for forming the thin film according to the present invention, the thin film may be an annular thin film of a piezoelectric material formed on the substrate which is to be a vibration plate for driving a printing head of an ink-jet printer.

Accordingly, by using the AD method, a film (layer) formed of a piezoelectric material can be formed easily.

In the method for forming the thin film according to the present invention, the thin film may be a metal thin film for an electrode formed on the annular thin film of the piezoelectric material.

Accordingly, an annular electrode (metallic thin film) can be formed easily by the AD method on the upper surface of an annular film (layer) formed of a piezoelectric material.

In the method for forming the thin film according to the present invention, a cross-sectional shape of the bridge portion with respect to a plane orthogonal to the predetermined direction may be an isosceles triangle or a trapezoid. In either case, since the bridge portion is tapered downwardly, the ultra-fine particles can easily go around the bridge portion to enter beneath the lower side of the bridge portion, which is advantageous for formation of the thin film having the shape corresponding to the pattern of the opening.

In the method for forming the thin film according to the present invention, the piezoelectric material may be lead zirconate titanate (PZT). In this case, a high-performance piezoelectric element formed of PZT can be formed.

In the method for forming the thin film according to the present invention, the mask may be formed of metal. In this case, the mask can be reused easily.

In the method for forming the thin film according to the present invention, the opening of the mask may be long in a first direction; and the bridge portion may extend in the first direction substantially at a center, of the opening, in a second direction orthogonal to the first direction. In this case, upon forming, for example, in a piezoelectric actuator used in a head for an ink-jet printer, a film of a piezoelectric material (piezoelectric layer) on a vibration plate covering a pressure chamber having a substantially elliptic shape, when the mask is arranged on the vibration plate, then the bridge portion overlaps with a substantial center, of the pressure chamber, in the short direction, and is extended in the longitudinal direction of the pressure chamber. In such a case, even when the thickness of the formed piezoelectric layer is slightly thinner at a portion overlapping with the bridge portions than at other portion, this hardly affects the function of the piezoelectric actuator.

According to a second aspect of the present invention, there is provided a mask which is used to form a thin film on a substrate by depositing, onto the substrate, ultra-fine particles jetted from a particle jetting apparatus, the mask including: a first member which is plate-shaped; a second member which is plate-shaped and which is arranged to surround the first member; an opening which is defined between the first member and the second member; and a bridge portion which connects the first and second members across the opening; wherein the bridge portion is formed at a position away from one surface of each of the first and second members.

Accordingly, in the AD method, for example, by arranging the mask on the substrate in a state that the mask is brought into contact with the substrate, a thin film having a pattern including an independent non-formation area can be formed. Also, the structure of the mask is simple.

### BRIEF DESCRIPTION OF THE DRAWINGS

FIGS. 1A and 1B each show a schematic structure of a thin-film forming apparatus according to the present invention, wherein FIG. 1A is a view showing a state when a thin film is formed, and FIG. 1B is a view showing a state when a substrate is set to the thin-film forming apparatus;

FIG. 2A is a plan view of a metal mask 2, and FIGS. 2B, 2C, 2D are cross-sectional views taken along a line IIB-IIB, a line IIC-IIC, and a line IID-IID shown in FIG. 2A, respectively;

FIG. 3A is a view showing a state that the metal mask is arranged on the substrate, and FIG. 3B is a view showing a state that ultra-fine particles are being jetted onto the substrate;

FIG. 4A is a plan view of a metal mask 21, FIG. 4B is a plan view of a thin film formed by the method according to the present invention, and FIG. 4C is a plan view showing a state in which an electrode is stacked (layered) on the thin film shown in FIG. 4B;

FIG. 5A is a view showing a state that a substrate is arranged, FIG. 5B is a view showing a state that a mask is arranged on the substrate, FIG. 5C is a view showing a state in which ultra-fine particles of metal are being jetted onto the substrate, FIG. 5D is a view showing a state that the mask is removed, and FIG. 5E is a view showing a state after calcination (sintering) has been performed;

FIG. 6A is a view showing a state that a substrate is arranged, FIG. 6B is a view showing a state that a resist film is formed on the substrate, FIG. 6C is a view showing a state that exposure is being performed, FIG. 6D is a view showing a state after the development, FIG. 6E is a view showing a state in which a metal film is formed on the exposed substrate, and FIG. 6F is a view showing a state that the resist film is removed;

FIG. 7 is a view for explaining a method for forming a thin film using a particle jetting apparatus having a plurality of nozzles;

FIG. 8 is a view for explaining a method for forming a thin film while moving a substrate reciprocally; and

FIGS. 9A to 9G are explanatory views showing cross sections of bridge portions respectively.

### DETAILED DESCRIPTION OF THE PREFERRED EMBODIMENTS

In the following, an embodiment of the present invention will be described with reference to the drawings.

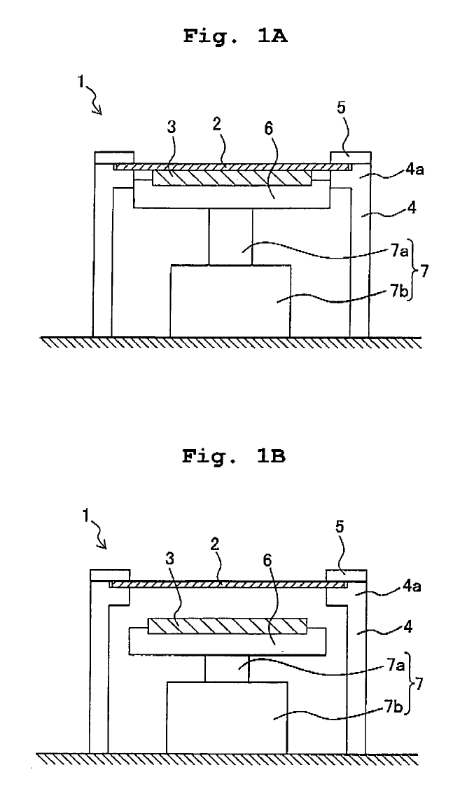

FIGS. 1A and 1B each show a schematic structure of a thin-film forming apparatus according to the present invention, wherein FIG. 1A is a view showing a state when a thin film is formed, and FIG. 1B is a view showing a state when a substrate is set to the thin-film forming apparatus.

As shown in FIG. 1A, a thin-film forming apparatus 1 includes a metal mask 2 which is plate-shaped and in which an opening is formed; a substrate 3; a substrate holder 6 in which the substrate is placed; a support stand 4 which supports the metal mask 2; a mask holder 5 which holds the metal mask 2 on the support stand 4; and an actuator 7 which adjusts the height of the substrate holder 6.

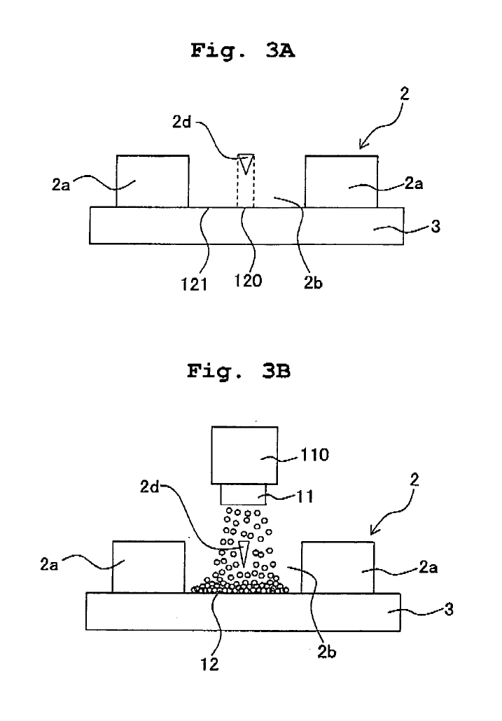

In the thin-film forming apparatus 1, the metal mask 2 (mask made of stainless steel), which is plate-shaped and in which an opening (ring-shaped opening) having a predetermined pattern (opening pattern) is formed, is arranged in a state that the metal mask 2 is in contact with the substrate 3 at the bottom surface of the metal mask 2. Ultra-fine particles for forming a thin film can be jetted, from a particle jetting apparatus 110 (see FIG. 3A), via the metal mask 2 to be deposited onto the substrate 3, thereby forming on the substrate 3 a thin film (not shown) with a shape corresponding to the opening pattern. Note that the thin-film forming apparatus 1 is arranged inside a chamber inside of which is decompressed by a decompressing apparatus such as a vacuum pump.

A support portion 4a is provided on an upper portion of the support stand 4, and the metal mask 2 is supported on the support portion 4a adjusted at a predetermined height. Further, the mask holder 5 is arranged at a position above (on the upper side of) the metal mask 2, and the metal mask 2 is held at a predetermined position with a predetermined height. The substrate 3 is supported on a substrate holder 6 at a position below the metal mask 2, and the height-position of this substrate holder 6 can be adjusted by the actuator 7. The actuator 7 includes a movable rod 7a supporting the substrate holder 6 horizontally, and a body (drive unit) 7b which changes a projecting (displacement) amount of the movable rod 7a. By the actuator 7, the substrate holder 6 and the substrate 3 are supported substantially in parallel with the metal mask 2.

By driving the actuator 7 to raise the substrate 3 (to move the substrate 3 in a direction approaching to the metal mask 2) so as to bring the upper surface of the substrate 3 into contact with the bottom surface of the metal mask 2. This state is a state upon forming a thin film (thin-film forming state, see FIG. 1A). The substrate 3 is positioned by an unillustrated positioning mechanism so that the substrate 3 has a predetermined positional relationship with the metal mask 2 held at the predetermined position and is held on the substrate holder 6. Note that instead of fixing the metal mask 2 shown in FIG. 1 to the predetermined position and moving the substrate 3, it is allowable that the substrate is fixed to a predetermined position and the metal mask may be moved in a vertical direction, or that both the substrate and the metal mask are moved.

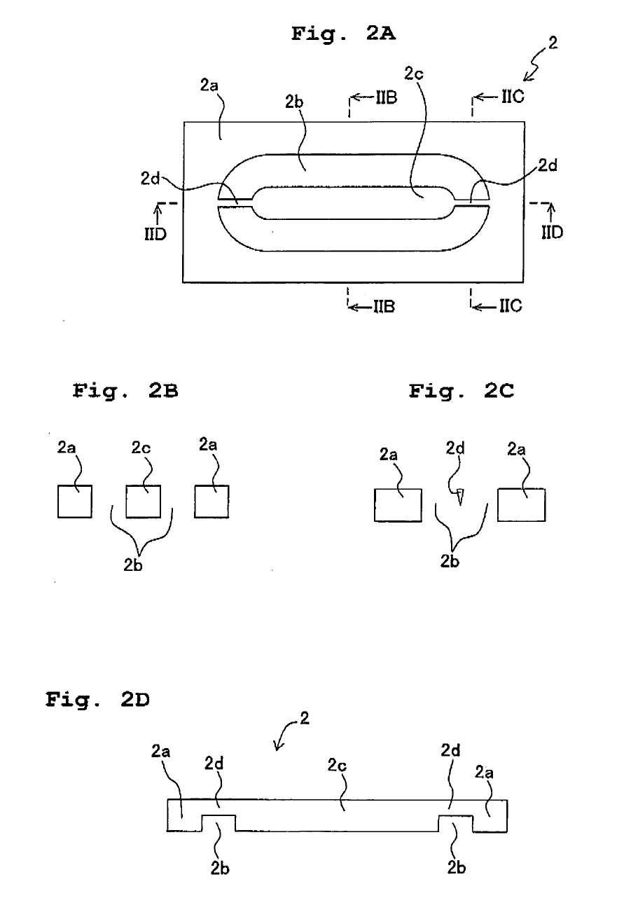

As shown in FIGS. 2A to 2D, the metal mask 2 has an outside frame (second area, second member, outer contour-defining portion) 2a which has a rectangular shape in plan view and which defines an outer contour of the ring-shaped opening; a shielding portion (first area, first member, island portion, independent portion) 2c which has an oval shape in plan view, which is arranged inside the outside frame 2a with the ring-shaped opening 2b being intervened between the shielding portion and the outside frame, and which defines an inner contour of the ring-shaped opening; and a plurality of bridge portions 2d each extending between the outside frame 2a and the shielding portion 2c and connecting the outside frame 2a and the shielding portion 2c. The bridge portions 2d are formed at positions away from the bottom surface (surface on which the metal mask makes a contact with the substrate) of the metal mask 2. Namely, the bridge portions 2d are formed on a side of the upper surface of the metal mask 2 (side opposite to the bottom surface of the metal mask 2). Then, when the metal mask 2 is arranged on the substrate 3 in a state that the bottom surface of the metal mask 2 is in contact with the substrate 3 (see FIG. 3B), there is defined a space between each of the bridge portions 2d and the substrate 3 since the bridge portions 2d are formed at the positions, respectively, away from the bottom surface of the metal mask 2.

Each of the bridge portions 2d has a cross-section which is a shape of an isosceles triangle, and which gradually becomes smaller (is tapered) toward the bottom surface of the metal mask 2. A cross-section, of the bridge portions 2d, orthogonal to the extending direction of the bridge portion is a symmetrical shape. The outside frame 2a is supported by the support stand 4 with the mask holder 5, and the shielding portion 2c is supported, via the bridge portions 2d, with respect to the outside frame 2a. Namely, the outside frame 2a is fixed on the support stand 4, thereby also fixing the shielding portion 2c. The bridge portions 2d each have a thickness which is not more than half a thickness of each of the outside frame 2a and the shielding portion 2c, but the bridge portions 2d have sufficient stiffness to support the shielding portion 2c. Note that when one of the bridge portions 2d has stiffness sufficient to support the shielding portion 2c, with respect to the outside frame 2a, then the other of the bridge portions 2d may be omitted. Further, positions at which the bridge portions 2d are provided may be arbitrary, provided that the bridge portions 2d have stiffness sufficient to support the shielding portion 2c with respect to the outside frame 2a.

Next, a method for forming a thin film will be explained. First, as shown in FIG. 3A, the metal mask 2 is arranged on the substrate 3 (first step). At this timer the upper surface of the substrate 3 and the bottom surface of the metal mask 2 are in contact with each other, and the metal mask 2 is not able to move on the substrate 3.

In a state that the substrate 3 and the metal mask 2 are in contact with each other, as shown in FIG. 3B, a nozzle 11 of the particle jetting apparatus 110 is arranged above the openings 2b of the metal mask 2. At this time, the distance between the nozzle 11 and the metal mask 2 is about 1 cm. Then, ultra-fine particles 12 having a particle size of about submicron (about 1 micron or less than 1 micron) are jetted through the nozzle 11 from a side of the upper surface of the metal mask 2. Thus, the ultra-fine particles 12 are deposited on the substrate 3. At this time, the ultra-fine particles 12 passing through the openings 2b reach the surface of the substrate 3 and are deposited on the substrate 3, so that a thin film having a shape corresponding to the shape of the opening 2b (opening pattern) is formed. Further, since the size of the ultra-fine particles 12 is very small as compared to the width of the bridge portions 2d, and since the ultra-fine particles 12 are jetted to spread in a jetting direction (downward in FIG. 3A), the ultra-fine particles 12 go around the bridge portions 2d to enter beneath the lower side of the bridge portions 2d. Namely, the ultra-fine particles 12 are deposited on areas (shadow areas 120), on the substrate 3, each of which overlaps in a plan view with one of the bridge portions 2d, thereby forming a thin film. In other words, regardless of the presence or absence of the bridge portions 2d, the ultra-fine particles 12 are deposited entirely on an area overlapping with the opening 2b of the substrate 3 (film-forming area 121) so as to form the thin film.

When it is difficult to jet the ultra-fine particles 12 entirely over the film-forming area 121 of the substrate 3 in a state that the substrate 3 is fixed at a position relative to the nozzle 11, it is allowable that the nozzle 11 jets the ultra-fine particles 12 toward the substrate 3 while the nozzle 11 moves relative to the substrate 3. For example, it is possible that the ultra-fine particles 12 are jetted over the entire film-forming area 121 of the substrate 3 while the nozzle 11 relatively moves in a direction which is parallel to a plane direction of the metal mask 2 and which is orthogonal to the extending direction of the bridge portions 2d, thereby depositing the ultra-fine particles 12 on the entire film-forming area 121. Here, by relatively moving the nozzle 11 in the direction orthogonal to the extending direction of the bridge portions 2d, the ultra-fine particles 12 easily go around the bridge portions 2d to enter beneath the lower side thereof. Further, the nozzle 11 of the particle jetting apparatus 110 may jet the ultra-fine particles 12 in a direction which is inclined with respect to the plane of the metal mask 2 and which intersects with the extending direction of the bridge portions 2d. Namely, the ultra-fine particles 12 may be jetted toward the metal mask 2 from a direction oblique to the metal mask 2.

After completing the film formation, the actuator 7 is driven to lower the substrate 3 to the initial position, and the substrate 3 and the metal mask 2 are separated from each other. Thereafter, the substrate 3 is exchanged, and the above-described steps are repeated so as to form a thin film on a substrate 3 sequentially.

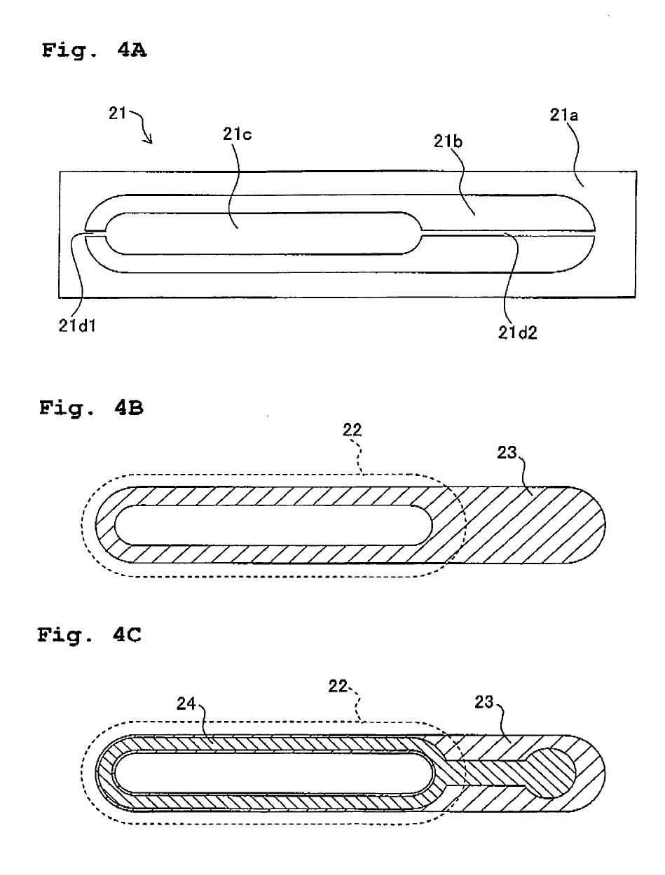

Such a film-forming method can be applied, for example, to a case of producing an annular thin film, made of a piezoelectric material on a vibration plate (substrate) as a piezoelectric layer for a piezoelectric actuator for driving a printing head of an ink-jet printer. For example, using a metal mask 21 shown in FIG. 4A, ultra-fine particles of a piezoelectric material (PZT or the like) are jetted toward a substrate to be deposited on the substrate, thereby making it possible to form an annular film 23 having a non-formation area which has a substantially oval shape corresponding to a pressure chamber 22 having a substantially oval shape, as shown in FIG. 4B. Here, the metal mask 21 has an outside frame 21a and a shielding portion 21c for forming a non-formation area on a substrate, and two bridge portions 21d1, 21d2; and the outside frame 21a and the shielding portion 21c are connected by the two bridge portions 21d1, 21d2, thereby defining an opening 21b for forming a film-forming area. In this case, when the metal mask 21 is arranged at a predetermined portion, the bridge portion 21d1 and the bridge portion 21d2 overlap with a substantial center, of a pressure chamber 22, in the short direction (second direction) and extend in the longitudinal direction (first direction) of the pressure chamber 22. Namely, the bridge portions 21d1 and 21d2 are formed at positions overlapping with both end portions, respectively, in the longitudinal direction of the pressure chamber 22 when the metal mask 21 is arranged at the predetermined position. In a piezoelectric actuator of pulling-ejection type (to be described later), an area overlapping with the pressure chamber at the both end portions in the longitudinal direction thereof contributes to the change of the volume of pressure chamber to a smaller extent than another area overlapping with the pressure chamber at both ends in the short direction thereof. Accordingly, upon forming a film of the piezoelectric material by using the metal mask 21, even when a thickness of the film become slightly thinner at an area thereof overlapping with the bridge portions than at other area of the film, this hardly influences to the operation of the piezoelectric actuator. The bridge portions of the metal mask may be formed at arbitrary positions provided that the bridge portions support the shielding portion. However, it is preferable that, if there are portions, in the film, which hardly influence the function of the film, the bridge portions are formed at positions corresponding to such areas even though the thickness of the formed film is partially decreased at such portions as a result as described above.

Further, as described above, by forming the film 23 of the piezoelectric material in an annular shape overlapping with the surrounding of the pressure chamber 22, it is possible to form a piezoelectric actuator for pulling-ejection with satisfactory drive efficiency. In general, a piezoelectric actuator has a film made of a piezoelectric material (piezoelectric layer), two electrodes formed to sandwich the piezoelectric layer. An area, of the piezoelectric layer, sandwiched between the two electrodes, is a deformable area (driving zone) which is deformed when voltage is applied to these electrodes. For example, a case is considered in which the piezoelectric actuator is arranged at a position above a pressure chamber in a state that the vibration plate (plate-shaped member) is sandwiched between the piezoelectric actuator and the pressure chamber. When the piezoelectric actuator is fixed to the vibration plate in a state that the deformable area is overlapped with the surrounding of the pressure chamber, then by applying a predetermined voltage to the electrodes of the piezoelectric actuator, the vibration plate can be warped upwardly at an area thereof overlapping with a central portion of the pressure chamber. At this time, since the volume of the pressure chamber is increased, the pressure inside the pressure chamber is decreased rapidly, thereby generating a negative pressure wave (first pressure wave) in the pressure chamber. When a period of time for the first pressure wave to propagate one-way in a longitudinal direction of the pressure chamber is elapsed, the pressure in the pressure chamber is changed to be positive. Then, when the voltage applied to the electrodes of the piezoelectric actuator is stopped at a timing at which the pressure wave in the pressure chamber changes to positive, the volume of the pressure chamber is returned to its original volume, thereby generating a positive pressure wave (second pressure wave). Since the first pressure wave which changed to positive and the second positive pressure wave are combined, a substantial pressure is applied to the ink in the pressure chamber so as to jet the ink from a nozzle communicating with the pressure chamber. Thus, it is possible to perform a so-called pulling ejection. At this time, the volume of the pressure chamber can be increased only for a period of time during which the voltage is being applied to the electrodes of the piezoelectric actuator. Therefore, there is no need to apply the voltage to the electrodes of the piezoelectric actuator also during a stand-by period, thereby making it possible to reduce the electric consumption and to suppress the degradation in polarization of the piezoelectric layer. In addition, by performing the pulling ejection, high pressure can be applied to the ink with a low drive voltage, thereby improving the drive efficiency of the piezoelectric actuator. In the piezoelectric actuator for the pulling-ejection, it is preferable that the piezoelectric layer is not formed in the piezoelectric actuator at an area thereof different from a driving zone. This is because that, when the piezoelectric layer (thin film made of piezoelectric material) is formed in the vibration plate on an entire area thereof overlapping with the pressure chamber, then this becomes a cause to hinder the deformation of the vibration plate upon jetting the ink. Therefore, it is preferable that the piezoelectric layer is formed in an annular shape as the film 23.

Next, as shown in FIG. 4C, an electrode 24 for pulling ejection is formed on the annular PZT film 23. The electrode 24 may be formed by a screen printing method or a sputtering. Alternatively, the electrode 24 may be formed by the AD method similarly to the annular film 23, for example.

A case of forming the electrode 24 with the AD method will be explained with reference to FIGS. 5A to 5E. First, as shown in FIG. 5A, a substrate 3 on which an annular film 23 is formed is arranged at a predetermined position. Next, as shown in FIG. 5B, a metal mask 31 is positioned on the annular film 23 and held in a state that the metal mask 31 and the annular film 23 are in contact with each other. Thereafter, as shown in FIG. 5C, ultra-fine particles (for example, ultra-fine particles of gold, copper, or the like) for forming the electrode are jetted toward the substrate 3 so as to form an electrode layer 24′. Subsequently, the metal mask 31 is removed (FIG. 5D), followed by being subjected to calcination, thereby forming the electrode 24 (FIG. 5E). Note that in the case of using the screen printing method, a printing mask is used instead of the metal mask 31; and instead of jetting ultra-fine particles, a conductive material or the like including metallic fine particles are jetted onto the substrate to be printed on the substrate, thereby making it possible to form the electrode 24 on the annular film 23 formed on the substrate 3.

Further, a case of forming the electrode 24 by the sputtering will be described with reference to FIGS. 6A to 6F. First, as shown in FIG. 6A, a substrate 3 on which an annular film 23 is formed is arranged at a predetermined position. As shown in FIG. 6B, resist formation (film resist) is performed to form a resist film 32 on the substrate 3 and the annular film 23. Then, as shown in FIG. 6C, in a state that a mask 33 is positioned and arranged on the resist film 32, exposure is performed by using an unillustrated exposure apparatus. After the mask 33 has been removed, the exposed substrate 3 etc. are subjected to development (FIG. 6D). Thus, the resist film is removed at an exposed area thereof, and the annular film 23 is exposed at a portion thereof at which the electrode 24 is to be formed. As shown in FIG. 6E, a metal film 34 is formed on the resist film 32 and the annular film 23 by the sputtering. Thereafter, the resist is removed so as to form the electrode 24 on the upper side of the annular film 23 (FIG. 5F).

Other than the above-described embodiments, the present invention can be changed as follows.

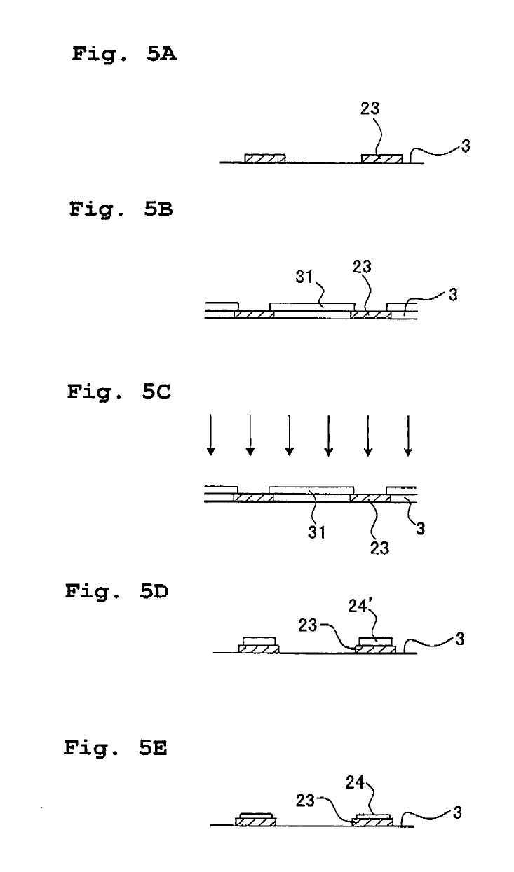

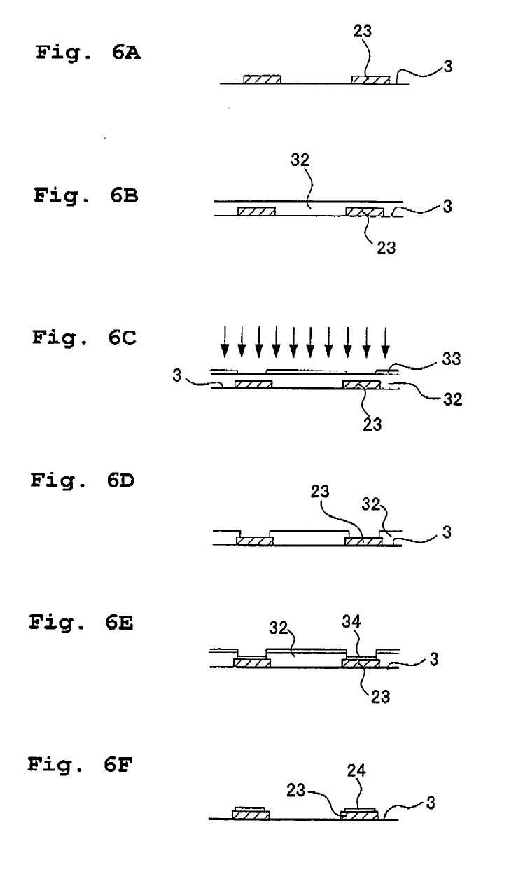

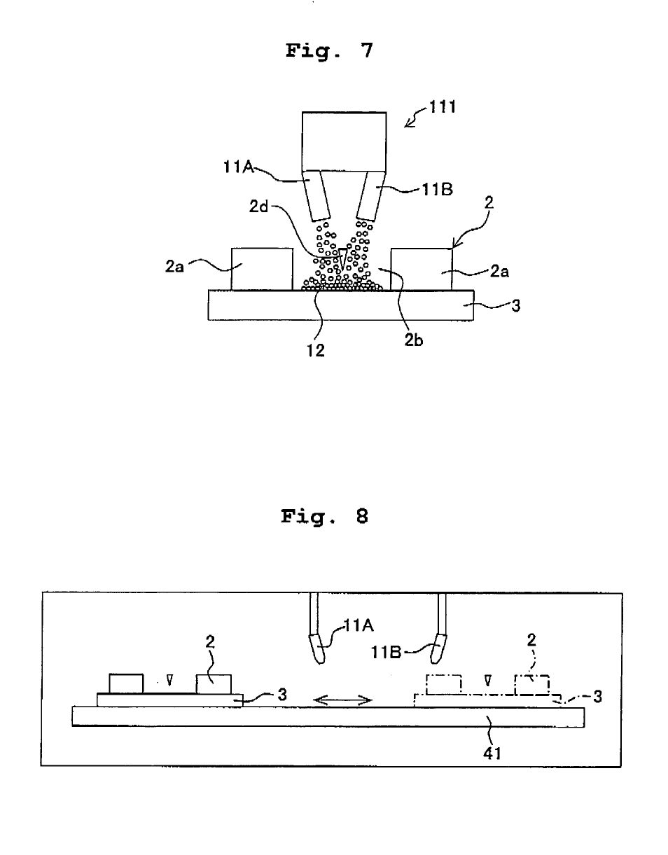

A particle jetting apparatus 111 shown in FIG. 7 has, instead of the single nozzle 11, a first nozzle 11A extending in a first direction which is inclined with respect to the plane of the metal mask 2, and a second nozzle 11B which is inclined with respect to the plane of the metal mask 2 and which extends in a second direction different from the first direction. In the second step, the ultra-fine particles 12 may be jetted alternatively from one of the first nozzle 11A and the second nozzle 11B, depending on a relative movement direction in which the particle jetting apparatus 111 moves relative to the substrate 3 and the metal mask 2. For example, as shown in FIG. 8, the substrate 3 and the metal mask 2 which are integrally formed (referred to as “substrate 3 etc.”) are arranged on a base 41, and while the substrate 3 etc. move reciprocally in a horizontal direction relative to the particle jetting apparatus 111, the particle jetting apparatus 111 may jet the ultra-fine particles 12 toward the substrate 3 etc. In this case, when the substrate 3 etc. move relative to the particle jetting apparatus 111, it is desirable that the bridge portions 2d extend in a direction orthogonal to the direction of relative movement between the particle jetting apparatus 111 and the substrate 3 etc., so as not to obstruct the deposition of the ultra-fine particles 12 on the substrate 3. Alternatively, it is allowable that the first nozzle 11A or the second nozzle 11B alternatively jets the ultra-fine particles 12 in a state that the substrate 3 etc. is stand sill with respect to the particle jetting apparatus 111. Still alternatively, it is allowable that the substrate 3 etc. is moved relative to the particle jetting apparatus 111, in a state that the ultra-fine particles 12 are jetted concurrently from the two nozzles 11A and 11B, so that the ultra-fine particles 12, jetted from only one of the nozzles 11A and 11B are deposited on a desired area of the substrate 3. In this case, the ultra-fine particles 12, jetted from the other of the nozzles 11A and 11B, are consequently deposited, for example, on outside the substrate or on the outer frame of the metal mask 2.

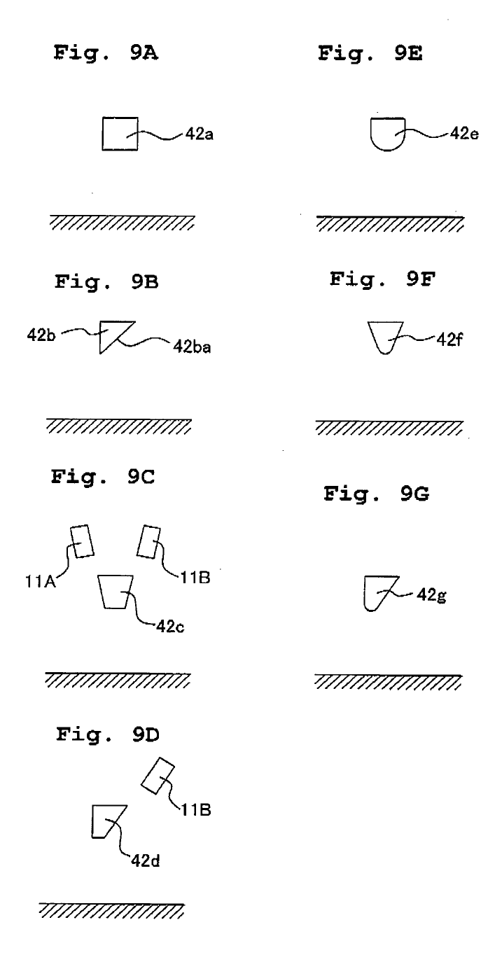

In the above-described embodiments, the bridge portions have a triangular cross-sectional shape so that the ultra-fine particles can easily go around the bridge portions to enter beneath the lower side of the bridge portions, but the present invention is not limited to such a construction. For example, it is allowable that the bridge portion has cross sections as shown in FIGS. 9A to 9G.

As a bridge portion 42a shown in FIG. 9A, the cross-sectional shape may be a substantially square shape. As a bridge portion 42b shown in FIG. 9B, the cross-sectional shape may be a right triangle shape in which only one side 42ba is an inclined plane. As bridge portions 42c, 42d shown in FIGS. 9C, 9D respectively, the upper and lower surfaces of the bridge portion may be flat surfaces and the cross-sectional shape thereof may be a trapezoidal shape. As shown in FIG. 9E, a bridge portion 42e may have a shape in which a lower surface of the bridge portion 42a is changed to a curved surface projecting (expanding) downward. Similarly, as shown in FIGS. 42F, 42G respectively, bridge portions 42f, 42g may have shapes in which lower surfaces of the bridge portions 42c, 42d are changed to curved surfaces projecting downward, respectively. Note that the shape (and the cross-sectional shape as well) of the bridge portion are not limited to the above examples, and may be arbitrary shape, provided that a sufficient gap is defined between the substrate and the bridge portion of the mask when the mask is arranged on the substrate, and that jetted ultra-fine particles can go around the bridge portion to reach the gap defined between the substrate and mask.

Although the present invention has been explained using a mask made of metal (metal mask) in the above-described embodiments and modification thereof, the material for the mask may be arbitrary provided that the mask can be reused. Further, it is not indispensably necessary that the upper surface (a surface on a side opposite to the substrate when the mask is arranged on the substrate) of the outside frame and/or the shielding portion of the mask are flush with the upper surface of the bridge portion. For example, the bridge portion may be formed in an arch shape curving upwardly higher than the upper surface of the outside frame of the mask. Alternatively, the distance between the mask and the nozzle and the particle size of the ultra-fine particles jetted from the nozzle are not limited to the above-described embodiments, and may be arbitrary.

A film formed by using the mask of the present invention may be different from those as shown in the embodiments and the modifications thereof. For example, it is also possible to form an insulating film by jetting ultra-fine particles of zirconia or alumina on a substrate via a mask.

What is claimed is:

1. A method for forming a thin film on a substrate, comprising:
a first step for arranging, on the substrate, a plate-shaped mask which has a first area, a second area which is arranged to surround the first area, an opening which is defined between the first area and the second area and which has a predetermined pattern, and a bridge portion extending in a predetermined direction to connect the first and second areas across the opening and arranged with a predetermined gap from one surface of the mask;
a step for arranging a particle jetting apparatus, which jets ultra-fine particles, at a position above the substrate and the mask; and
a second step for jetting the ultra-fine particles by the particle jetting apparatus from a side of an upper surface of the mask so as to form a thin film, which has a shape corresponding to the predetermined pattern, on the substrate.

2. The method for forming the thin film according to claim 1, wherein the bridge portion is tapered toward the one surface of the mask.

3. The method for forming the thin film according to claim 1, wherein in the second step, the particle jetting apparatus jets the ultra-fine particles in a direction which is inclined with respect to the one surface of the mask and which intersects with the predetermined direction.

4. The method for forming the thin film according to claim 1, in the second step, the particle jetting apparatus jets the ultra-fine particles while moving reciprocally relative to the mask in a direction which is parallel to the one surface of the mask and is orthogonal to the predetermined direction.

5. The method for forming the thin film according to claim 1, wherein the particle jetting apparatus has a nozzle which jets the ultra-fine particles in a direction oblique to the mask.

6. The method for forming the thin film according to claim 4, wherein the particle jetting apparatus has a first nozzle which jets the ultra-fine particles in a first direction inclined with respect to the one surface of the mask, and a second nozzle which jets the ultra-fine particles in a second direction inclined with respect to the one surface of the mask and different from the first direction; and
in the second step, the ultra-fine particles are jetted alternatively from one of the first nozzle and the second nozzle depending on a moving direction in which the particle jetting apparatus is moved relative to the mask.

7. The method for forming the thin film according to claim 1, wherein a cross-sectional shape of the bridge portion with respect to a plane orthogonal to the predetermined direction is symmetrical.

8. The method for forming the thin film according to claim 1, wherein the thin film is an annular thin film of a piezoelectric material formed on the substrate which is to be a vibration plate for driving a printing head of an ink-jet printer.

9. The method for forming the thin film according to claim 8, wherein the thin film is a metal thin film for an electrode formed on the annular thin film of the piezoelectric material.

10. The method for forming the thin film according to claim 1, wherein a cross-sectional shape of the bridge portion with respect to a plane orthogonal to the predetermined direction is an isosceles triangle.

11. The method for forming the thin film according to claim 1, wherein a cross-sectional shape of the bridge portion with respect to a plane orthogonal to the predetermined direction is a trapezoid.

12. The method for forming the thin film according to claim 8, wherein the piezoelectric material is lead zirconate titanate.

13. The method for forming the thin film according to claim 1, wherein the mask is formed of metal.

14. The method for forming the thin film according to claim 8, wherein the opening of the mask is long in a first direction; and the bridge portion extends in the first direction substantially at a center, of the opening, in a second direction orthogonal to the first direction.

15. A mask which is used to form a thin film on a substrate by depositing, onto the substrate, ultra-fine particles jetted from a particle jetting apparatus, the mask comprising:
a first member which is plate-shaped;
a second member which is plate-shaped and which is arranged to surround the first member;
an opening which is defined between the first member and the second member; and
a bridge portion which connects the first and second members across the opening;
wherein the bridge portion is formed at a position away from one surface of each of the first and second members.

16. The mask according to claim 15, wherein the bridge portion is tapered toward the one surface of the mask.

17. The mask according to claim 15, wherein the bridge portion extends in a predetermined direction; and
a cross-sectional shape of the bridge portion with respect to a plane orthogonal to the predetermined direction is an isosceles triangle.

18. The mask according to claim 15, wherein the bridge portion extends in a predetermined direction; and
a cross-sectional shape of the bridge portion with respect to a plane orthogonal to the predetermined direction is a trapezoid.

19. The mask according to claim 15, wherein the mask is made of metal.

20. The mask according to claim 15, wherein the opening is long in a first direction; and the bridge portion extends in the first direction substantially at a center, of the opening, in a second direction orthogonal to the first direction.
